(19) United States
(12) Patent Application Publication
(10) Pub. No.: US 2026/0128763 A1
(43) Pub. Date: May 7, 2026

(54) METHODS AND APPARATUS FOR RESOLVING STATION ID CONFLICT IN COORDINATED BEAMFORMING

(71) Applicant: HUAWEI TECHNOLOGIES CO., LTD., SHENZHEN (CN)

(72) Inventors: Mahmoud HASABELNABY, Kanata (CA); Jung Hoon SUH, Kanata (CA); Yan XIN, Kanata (CA); Osama ABOUL-MAGD, Kanata (CA); Sara NOROUZI, Kanata (CA)

(73) Assignee: HUAWEI TECHNOLOGIES CO., LTD., SHENZHEN (CN)

(21) Appl. No.: 19/060,181

(22) Filed: Feb. 21, 2025

Related U.S. Application Data
(60) Provisional application No. 63/717,589, filed on Nov. 7, 2024.
(60) Provisional application No. 63/727,275, filed on Dec. 3, 2024.

(51) Int. Cl. H04B 7/024

(52) U.S. Cl. CPC H04B 7/024

(57) ABSTRACT

Methods and apparatus for configuring coordinated beamforming among multiple APs which mitigate or prevent station ID collisions between STAs associated with different collaborating Basic Service Sets are provided. A common BSS color is used for all STAs in the U-SIG field of a Co-BF PPDU. A disambiguation bit may be used in the UHR-SIG field to determine with which of two APs a STA is associated. The Initial Control Frame and Initial Control Response sequence can be leveraged to assign new STA IDs to STAs with conflicting STA IDs. STA ID conflicts can be prevented by assigning overlapping APs unique sets of most significant bits to use for all of their STA IDs.

### CROSS-REFERENCE TO RELATED APPLICATIONS

This application claims priority to U.S. Provisional Patent Application No. 63/727,275, filed Dec. 3, 2024, U.S. Provisional Patent Application No. 63/717,589, filed Nov. 7, 2024, the contents of which are incorporated herein by reference.

### FIELD OF THE INVENTION

The present invention pertains to wireless communication systems, and in particular to a method and apparatus for coordinated beamforming transmissions in wireless communication systems.

### BACKGROUND

A Wireless Local Area Network (LAN) according to IEEE 802.11 specifications has at least one Basic Service Set (BSS) composed of an access point (AP) and one or more non-access point stations (STAs) associated therewith. Beamforming is the systematic driving of pluralities of antennas belonging to one or more APs or STAs to create constructive interference in a primary direction to boost the signal power reaching a target receiver while nulling the signal in the direction of unintended receivers. Basic service sets can be said to overlap when regions of space lie within a useful communication range of more than one Access Point.

In Wireless LAN scenarios with Overlapping Basic Service Sets (OBSSs), Coordinated Beamforming (Co-BF or COBF) is a technique in which multiple Access Points (APs) collaborate to optimize downlink (DL) transmissions, improving signal strength and minimizing interference for their associated non-AP-STAs (Stations) within a shared wireless environment. In a typical Co-BF setup, two APs—the “sharing AP” and the “shared AP”—synchronize their downlink transmissions to create a coordinated beam, nullifying their signals towards the STAs served by each AP during a specific Transmission Opportunity (TXOP). This strategy mitigates interference from neighboring networks, allowing for more efficient spectrum utilization and enhancing overall network performance. The coordination between the sharing AP and shared AP is critical for improving the reliability and efficiency of wireless transmissions in dense environments, such as office buildings or residential areas with multiple networks operating in proximity. By minimizing interference and optimizing the downlink signals toward non-AP STAs, Co-BF can significantly boost throughput and reduce congestion, ultimately leading to better user experiences in wireless networks.

As detailed in the approved motions #99 and #114 for IEEE 802.11bn standard, there are certain restrictions placed on the number of APs and STAs involved in Co-BF transmissions. Specifically, IEEE 802.11bn standard limits the number of APs to two and the maximum number of STAs to four in a Co-BF transmission. This limitation is designed to simplify the coordination process and keep the system's complexity manageable. This is also because, in typical scenarios, if more than three users belong to a single AP, the AP may not have sufficient resources (spatial dimensions) available to nullify signals effectively, which can degrade performance. By limiting the total number of users to four, the system can provide good spatial multiplexing opportunities while maintaining processing simplicity, akin to regular Multi-User Multiple Input Multiple Output MU-MIMO (Multi-User MIMO) configurations. Additionally, IEEE 802.11bn standard places further constraints to simplify both signaling and testing by capping the maximum total spatial streams to four and limiting each STA to a maximum of two spatial streams.

Methods of configuration of coordinated beamforming to resolve station address conflicts in a multi-AP collaboration scenario are therefore desired that mitigate one or more deficiencies in the prior art, to enhance the coordination of downlink transmissions between APs, ensuring reliable communication and optimizing network performance.

### SUMMARY

The primary technical challenge addressed by embodiment of the present disclosure is the STA ID (Station Identifier) conflict issue in Coordinated Beamforming (Co-BF, COBF) downlink transmissions. Since STA IDs are typically assigned independently by each AP in a Co-BF setup, there is a risk of collisions when multiple APs transmit simultaneously within the same downlink PPDU (Physical Protocol Data Unit). This can lead to confusion for non-AP STAs, as they may be unable to determine which BSS (Basic Service Set) or AP the received transmission belongs to, which can result in incorrect data reception or interference.

Another issue is the efficient utilization of the Physical Layer (PHY) preamble, which is limited in terms of available bits. Current solutions in the prior art often require dedicating bits in the PHY preamble, which is not optimal given the value of every bit in this space. This can lead to wasted resources and a reduction in overall system efficiency.

Furthermore, scalability is an important concern. Existing solutions in the prior art typically support only two APs in Co-BF at a time, which limits their applicability in future wireless networks where more than two APs might be involved in a single coordinated transmission. A scalable solution is therefore advantageous in enabling to accommodate more than two APs, facilitating the system the evolution with and adaptability to future generations of wireless technology.

Finally, there is the challenge of minimizing the overhead during the Multi-AP (MAP) coordination negotiation phase. While addressing STA ID conflicts using exiting methods during the MAP negotiation phase could offer a solution, it introduces additional complexity and overhead, which may not be ideal for network performance and efficiency. The present invention pertains resolving one or more of these technical problems by providing more efficient, scalable, and low-overhead solutions to manage STA-ID conflicts in Co-BF.

According to a first broad aspect of the present disclosure, a method is provided, at a second Access Point (AP), of uniquely identifying wireless local area network (WLAN) stations (STAs) for participation in a Multi-AP Coordinated Beamforming (Co-BF) Agreement between a first AP and the second AP, the method comprising receiving a frame from a first access point comprising an indication of a common BSS color for the coordination agreement, transmitting an Initial Control trigger frame to one or more STAs associated with the second AP, the Initial Control trigger frame comprising an indication of the common BSS color, and receiving an Initial Control Response trigger-based frame from one or more of the STAs associated with the second AP, the Initial Control Response frame comprising at least one indication of a STA's readiness to participate in the Multi-AP Co-BF Agreement.

According to embodiments, the method comprises transmitting simultaneously with the first AP a Co-BF DL PPDU comprising a U-SIG field and a UHR-SIG field, the U-SIG field containing an indication of the common BSS color, and the UHR-SIG field comprising a User Info field containing a STA ID and a bit value indicating whether the STA ID belongs to a STA associated with the first AP or the second AP.

According to a second aspect of the present disclosure, the Initial Control Trigger frame comprises an Extended User Info field containing a first STA ID of a STA associated with the second AP, the first STA ID equal to a STA ID of a STA associated with the first AP, and an updated STA ID for assignment to the STA associated with the second AP, said updated STA ID unequal to any STA ID of any STA associated with the first AP.

According to a third aspect of the present disclosure, a method is disclosed of allocating a range of station (STA) identifiers to an access point comprising transmitting from the access point a public action frame comprising an Association ID (AID) range negotiation element, the AID range negotiation element containing a lower bounding AID and an upper bounding AID, the lower bounding AID being of the form N(2^{m}) wherein m is a positive integer equal to 8, 9, or 10, N is an integer from 0 to (2048/2^{m})−1, 2048/2^{m} represents a number of pools of Co-BF STA IDs available to reserve for access points, and the upper bounding AID is a minimum value among (N+1)(2^{m})−1 and 2006.

According to embodiments of the third aspect, the method further comprises reserving for the access point a pool of temporary 11-bit Co-BF STA IDs, the pool of temporary 11-bit Co-BF STA IDs being all 11-bit STA IDs sharing a same one, two or three Most Significant Bits (MSBs).

According to embodiments of all aspects of the present disclosure, an electronic communication device comprises a processor and stores in a memory instructions that when executed by the processor cause the device to perform any of the aforementioned methods.

According to embodiments, there is provided a method that includes, at a sharing access AP of a wireless communication network, transmitting, towards a shared AP of the wireless communication network. The first ICF includes an indication of a BSS color to be used in a joint transmission of a Co-BF downlink (DL) physical layer protocol data unit (PPDU) by the sharing AP and the shared AP. The first ICF includes an indication of a first plurality of STAs associated with the sharing AP. The method includes, at the sharing AP, receiving, from the shared AP, an initial control response (ICR) indicative of a participation of the shared AP in the joint transmission of the Co-BF DL PPDU, and indicative of a second plurality of STAs associated with the shared AP.

According to an embodiment, the method may include transmitting, towards the shared AP, a Co-BF trigger for the joint transmission of the Co-BF DL PPDU, and transmitting the Co-BF DL PPDU having the common BSS color.

According to an embodiment, transmitting the first ICF towards the shared AP may include transmitting the first ICF towards both the shared AP and the first plurality of STAs. The ICF may further include an indication of a first set of STA identifiers (IDs) for the first plurality of STAs.

According to an embodiment, the method may include transmitting, towards the first plurality of STAs, an indication of a first set of STA IDs for the first plurality of STAs, STA IDs of the first set of STA IDs being distinct from STA IDs of a second set of STA IDs for the second plurality of STAs. The STA IDs of the first set of STA IDs and the STA IDs of the second set of STA IDs may be selected from an Association Identifier (AID) pool comprising 2006 AIDs. Each STA ID of the first set of STA IDs may include a same 2 or 3 bit BSS ID.

According to an embodiment, the method may include receiving, from the shared AP, a second ICF that includes an indication of a second set of STA IDs associated with the shared AP, STA IDs within the second set of STA IDs being distinct from STA IDs within the first set of STA IDs.

According to an embodiment, the first ICF may further include one or more of: a multi-AP (MAP) agreement identifier (ID) associated with the joint transmission of the Co-BF DL PPDU; a Co-BF instance ID associated with the joint transmission of the Co-BF DL PPDU; an indication of a first set of station (STA) identifiers (IDs) for a first plurality of STAs associated with the sharing AP, the STAs of the first plurality of STAs being ready and available for receiving the joint transmission of the Co-BF DL PPDU; a 1-bit indication of a presence of an enhanced multi-link single radio (eMLSR) STA or a dynamic power saving (DPS) STA in the first plurality of STAs; a carrier frequency offset (CFO) precorrection value; precoding parameters; a Sounding Dialog Token Number; and additional control information associated with the joint transmission of the Co-BF DL PPDU.

According to an embodiment, the ICR may further include one or more of: a 1-bit indication of a presence of an enhanced multi-link single radio (eMLSR) STA or a dynamic power saving (DPS) STA in the second plurality of STAs; a carrier frequency offset (CFO) precorrection value; precoding parameters; and a Sounding Dialog Token Number.

According to an embodiment, the method may include, at the sharing AP, determining that no STA within the first plurality of STAs can participate in receiving data associated with the joint transmission of the Co-BF DL PPDU, and sharing, with the shared AP, a transmission opportunity (TXOP) associated with the joint transmission of the Co-BF DL PPDU, using Coordinated Time Division Multiple Access (Co-TDMA).

According to embodiments, the common BSS color may be one of: a Co-BF instance ID associated with the joint transmission of the Co-BF DL PPDU; a BSS color of the sharing AP; a pre-negotiated BSS color; and a negotiated value.

According to embodiments, the first ICF may be a trigger frame or a public action frame.

According to embodiments, there is provided another method that includes, at a shared AP of a wireless communication network, receiving, from a sharing AP of the wireless communication network, a first ICF. The first ICF includes an indication of a common BSS color to be used in a joint transmission of a Co-BF DL PPDU by the sharing AP and the shared AP. The first ICF includes an indication of a first plurality of STAs associated with the sharing AP. The method includes transmitting, at the shared AP, towards a second plurality of STAs associated with the shared AP, an indication of the common BSS color.

According to an embodiment, the method may include, at the shared AP, transmitting, towards the sharing AP and the second plurality of STAs, a second ICF indicative of a participation of the shared AP in the joint transmission of the Co-BF DL PPDU and indicative of the second plurality of STAs. The second ICF may include the indication of the common BSS color.

According to an embodiment, the method may include, at the shared AP, transmitting, towards the second plurality of STAs, an indication of a first set of STA IDs for the second plurality of STAs, STA IDs of the first set of STA IDs being distinct from STA IDs of a second set of STA IDs for the first plurality of STAs associated with the sharing AP. The indication of the common BSS color and the indication of the first set of STA IDs may be transmitted jointly. The STA IDs of the first set of STA IDs and the STA IDs of the second set of STA IDs may be selected from an Association Identifier (AID) pool comprising 2006 AIDs. Each STA ID of the first set of STA IDs comprises a same 2 or 3 bit BSS ID. The method may further include receiving, from the sharing AP, an indication of the second set of STA IDs, the second set of STA IDs including a first STA ID, a STA of the second plurality of STAs having the first STA ID, wherein the first set of STA IDs includes a new STA ID for the STA of the second plurality of STAs, the new STA ID being distinct from the first STA ID. The first ICF may include the indication of the second set of STA IDs.

According to an embodiment, the method may include, at the shared AP, receiving, from the sharing AP, a Co-BF trigger for the joint transmission of the Co-BF DL PPDU, and transmitting the Co-BF DL PPDU having the common BSS color.

According to an embodiment, the method may include, at the shared AP, transmitting, toward the sharing AP. The ICR may be indicative of a participation of the shared AP in the joint transmission of the Co-BF DL PPDU. The ICR may be indicative of the second plurality of STAs associated with the shared AP. The ICR may be indicative of one or more of: a 1-bit indication of a presence of an enhanced multi-link single radio (eMLSR) STA or a dynamic power saving (DPS) STA in the second plurality of STAs; a carrier frequency offset (CFO) precorrection value; precoding parameters; and a Sounding Dialog Token Number.

According to an embodiment, the method may include, at the shared AP, receiving, from the sharing AP, a transmission opportunity (TXOP) associated with the joint transmission of the Co-BF DL PPDU, using Coordinated Time Division Multiple Access (Co-TDMA).

According to embodiments, there is provided a sharing AP of a wireless communication network. The sharing AP is configured to transmit, towards a shared AP of the wireless communication network, a first ICF that includes an indication of a common BSS color to be used in a joint transmission of a Co-BF DL PPDU by the sharing AP and the shared AP, and an indication of a first plurality of STAs associated with the sharing AP. The sharing AP is configured to receive, from the shared AP, a first ICR indicative of a participation of the shared AP in the joint transmission of the Co-BF DL PPDU, and indicative of a second plurality of STAs associated with the shared AP.

According to embodiments, there is provided a shared AP of a wireless communication network. The shared AP is configured to receive, from a sharing AP of the wireless communication network, a first ICF that includes an indication of a common BSS color to be used in a joint transmission of a Co-BF DL PPDU by the sharing AP and the shared AP, and an indication of a first plurality of STAs associated with the sharing AP. The shared AP is configured to transmit, towards a second plurality of STAs associated with the shared AP, an indication of the common BSS color.

According to embodiments, the shared AP may be further configured to transmit, toward the sharing AP, an ICR. The ICR may be indicative of a participation of the shared AP in the joint transmission of the Co-BF DL PPDU, the second plurality of STAs associated with the shared AP, and one or more of: a 1-bit indication of a presence of an enhanced multi-link single radio (eMLSR) STA or a dynamic power saving (DPS) STA in the second plurality of STAs; a carrier frequency offset (CFO) precorrection value; precoding parameters; and a Sounding Dialog Token Number.

According to embodiments, multiple methods or apparatuses may interact together in a system, each method or apparatus as described above, and in the presence of each other.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 schematically illustrates a basic service Set (BSS) based multi-AP environment.

FIG. 2 is a schematic diagram of a device that may perform any or all operations of the above methods and features explicitly or implicitly described herein, according to different embodiments of the present invention.

FIG. 3 is a schematic diagram of a UHR PPDU comprising a non-beamformed Pre-UHR portion and a beamformed UHR portion.

FIG. 4 is an illustration of a STA-ID collision in which two STAs possess the same AID12, assigned independently by two different APs at time of association.

FIG. 5 is a schematic diagram of a prior art STA-ID conflict solution with two BSS colors in U-SIG and a BSS disambiguation bit in the UHR-SIG user record.

FIG. 6 is a messaging diagram describing Co-BF setup with shared AP and STAs responding separately to distinct Co-BF Invite and Initial Control Frame (ICF) according to an embodiment of the present invention.

FIG. 7 is a messaging diagram describing Co-BF setup with shared AP and STAs responding simultaneously to a combined Co-BF Invite and ICF according to an embodiment of the present invention.

FIG. 8 is a messaging diagram describing Co-BF setup wherein shared AP's ICF signals its STAs a common BSS color for the Co-BF instance according to an embodiment of the present invention.

FIG. 9 is a schematic diagram of the detailed format of the Co-BF Invite Information Field in Table 2.

FIG. 10 is a schematic diagram of the detailed format of the Co-BF Response Information Field in Table 6.

FIG. 11 is a schematic diagram of the format of an Extended Special User Info Field of the BSRP-based General ICF trigger frame according to an embodiment of the invention.

FIG. 12 is a schematic diagram of the format of the specific Extended Special User Info Field of the BSRP-based Co-BF trigger frame according to an embodiment of the invention.

FIG. 13 is a messaging diagram describing Co-BF setup with shared AP and STAs responding simultaneously to a combined Co-BF Invite and ICF according to an embodiment of the present invention.

FIG. 14 is a messaging diagram describing Co-BF setup wherein shared AP's ICF signals its STAs a common BSS color for the Co-BF instance and any required AID updates according to an embodiment of the present invention.

FIG. 15 is a schematic diagram of the format of the Extended User Info Field for general BSRP-based ICF trigger frames according to an embodiment of the invention.

FIG. 16 is a schematic diagram of the format of the specific Extended User Info Field for BSRP-based Co-BF trigger frames according to an embodiment of the invention.

FIG. 17 is a messaging diagram describing Co-BF setup with shared AP and STAs responding simultaneously to a combined Co-BF Invite and ICF with STA-ID collision resolution according to an embodiment of the present invention.

It will be noted that throughout the appended drawings, like features are identified by like reference numerals.

### DETAILED DESCRIPTION

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to.

A wireless communications system, to which embodiments of the present disclosure are applicable, may include one or more wireless local area network (wireless local area network, WLAN) devices, referred to herein as stations (STAs) and one or more AP. A STA may be a mobile STA, but that is not a requirement. For example, as will be apparent, embodiments of the disclosure are applicable for fixed STAs or APs. The communications device may be a wireless communications device that supports other wireless protocols.

Multi-AP collaboration schemes have been discussed as main candidate features for adoption in wireless LAN (WLAN) IEEE 802.11 standards. Enabling some degree of coordination among neighboring APs permits more efficient utilization of limited wireless resources, such as time, frequency, power, and spatial resources. Additionally, enabling information sharing among coordinated APs (i.e., user scheduling and channel quality information) can ameliorate co-channel interference which can become unbearable in increasingly densified wireless networks. Therefore, embodiments allow for multi-AP coordination which can turn the interfering APs into collaborative sounding and beamforming participants for STAs located at overlapped basic service sets (BSSs). Throughout the present disclosure, Multi-AP collaboration is to be construed as (e.g., two or more) APs functioning together to achieve a common communication goal such as sounding, beamforming, a coordinated transmission, or a combination thereof. Multi-AP Coordination is to be construed as APs functioning independently in an overlapping setting to achieve separate communication goals while actively avoiding interfering with one another. While spatial reuse and channel puncturing are examples of means to achieve Multi-AP Coordination through reduction of interference, coordinated beamforming is a means to achieving Multi-AP Collaboration through synergy, rather than mere noninterference, of multiple APs.

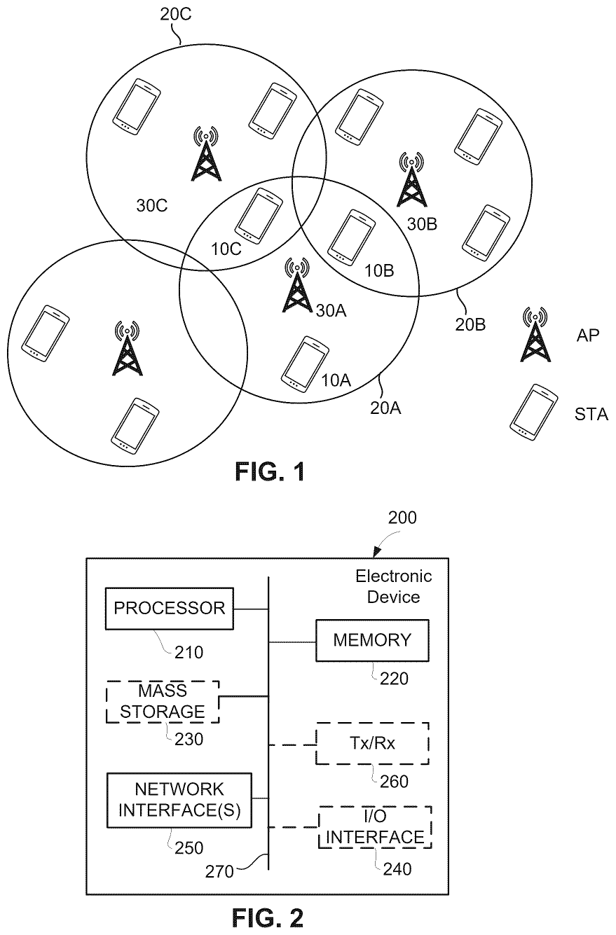

FIG. 1 schematically illustrates a basic service set (BSS) based environment. Each BSS 20 is served by an AP 30. Accordingly, BSS 20A is served by AP 30A, BSS 20B is served by AP 30B, and BSS 20C is served by AP 30C. As can be seen STA 10A is within BSS 20A, whereas STA 10B is within both BSS 20A and BSS 20B, and STA 10C is within both BSS 20C and BSS 20A. STA 10A, being within BSS 20A, would be served by (or associated with) AP 30A. STA 10B being within both BSS 20A and BSS 20B, could be served by AP 30A or 30B. However, if STA 10B is served by AP 30A, it may receive co-channel interference from AP 30B. Coordinated beamforming is a proposed solution to such co-channel interference. The present disclosure teaches several novel solutions to address the STA AID conflict issue in Coordinated Beamforming downlink transmissions, facilitating seamless operation in multi-AP environments.

FIG. 2 is a schematic diagram of a device 200 that may perform any or all of operations and steps of the above methods and features explicitly or implicitly described herein, according to different embodiments of the present disclosure. For example, a computer, a physical machine, a server, or another computing device equipped with network function may be configured as device 200. As may be appreciated by a person skilled in the art, the device 200 can represent one or more entities described herein, for example, an AP, a STA, or the like.

As shown, the device 200 may include a processor 210, such as a central processing unit (CPU), a neural processing unit (NPU), or specialized processors such as a graphics processing unit (GPU) or other such processor unit, memory 220, non-transitory mass storage 230, input-output interface 1040, network interface 250, and a transceiver 260, all of which are communicatively coupled via bi-directional bus 270. According to certain embodiments, any or all of the depicted elements may be utilized, or only a subset of the elements. Further, device 200 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 220 may include any type of non-transitory memory such as static random access memory (SRAM), dynamic random access memory (DRAM), synchronous DRAM (SDRAM), read-only memory (ROM), any combination of such, or the like. The mass storage element 230 may include any type of non-transitory storage device, such as a solid state drive, hard disk drive, a magnetic disk drive, an optical disk drive, USB drive, or any computer program product configured to store data and machine executable program code. According to certain embodiments, the memory 220 or mass storage 230 may have recorded thereon statements and instructions executable by the processor 210 for performing any of the aforementioned method operations described above.

Embodiments of the present invention can be implemented using electronics hardware, software, or a combination thereof. In some embodiments, the invention is implemented by one or multiple computer processors executing program instructions stored in memory. In some embodiments, the invention is implemented partially or fully in hardware, for example using one or more field programmable gate arrays (FPGAs) or application specific integrated circuits (ASICs) to rapidly perform processing operations.

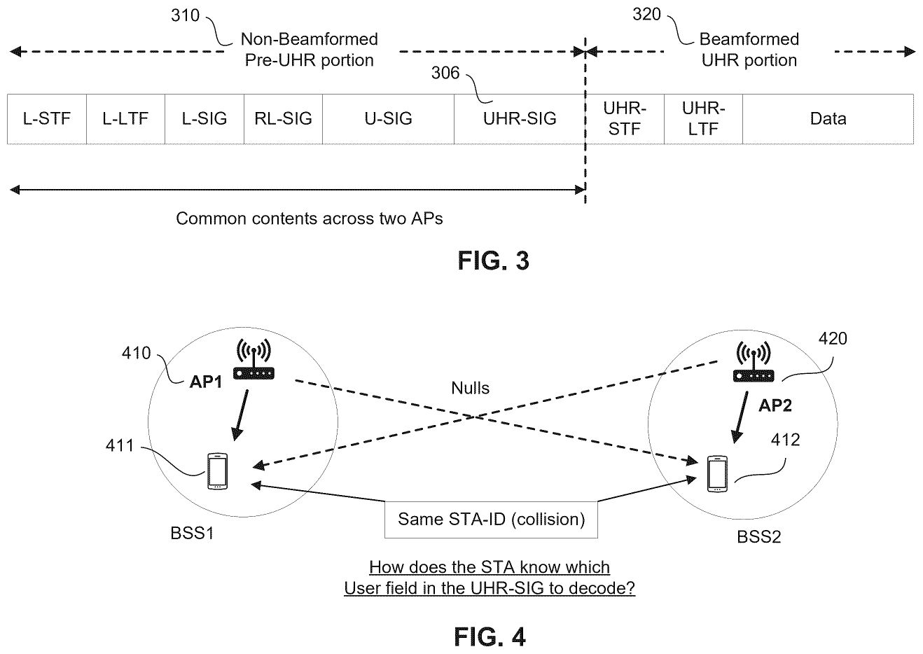

Regarding the physical layer (PHY) preamble, IEEE 802.11bn standard introduces a division between the Non-Beamformed Pre-Ultra High Reliability (UHR) portion 310 and the Beamformed UHR portion 320, as shown in FIG. 3. The Non-Beamformed Pre-UHR portion 310 has to be “identical” across both APs, ensuring uniformity in the signal format. However, the user fields in the UHR-SIG 306 located in the common Pre-UHR portion 310 need to clearly indicate which AP is transmitting the DL PPDU transmission. This differentiation is crucial because relying on independently assigned STA IDs (Station Identifiers) by each AP, located within the user field, can lead to STA ID conflict if both APs assign the same STA ID to different STAs that are served in the same shared TXOP. An example of such a conflict is illustrated in FIG. 4, where the first AP1 410 independently assigned a first ID to its served STA1 411, while the second AP2 420 independently assigned the same first ID to its served STA2 412, resulting in the STA ID conflict during joint transmission of Co-BF DL PPDU by AP1 410 and AP2 420.

To prevent such conflicts and ensure that (non-AP) STAs can accurately identify which BSS (Basic Service Set) or AP the received DL PPDU belongs to or is being received from, addressing the STA ID collision issue is important. The challenge lies in efficiently distinguishing between the APs involved in the Co-BF transmission while maintaining the integrity of the PHY preamble and minimizing overhead. This is particularly important for ensuring smooth operation, reliable service delivery, and seamless user experience across all STAs in the network.

An example proposed solution to the STA ID conflict is disclosed in U.S. Provisional Patent Application No. 63/717,589. APs may negotiate, during Co-BF setup, non-overlapping ranges of STA IDs each AP is allowed to use in the Co-BF, eliminating the possibility of a STA ID conflict. However, this uses up some of the TXOP time on dedicated frames for this purpose.

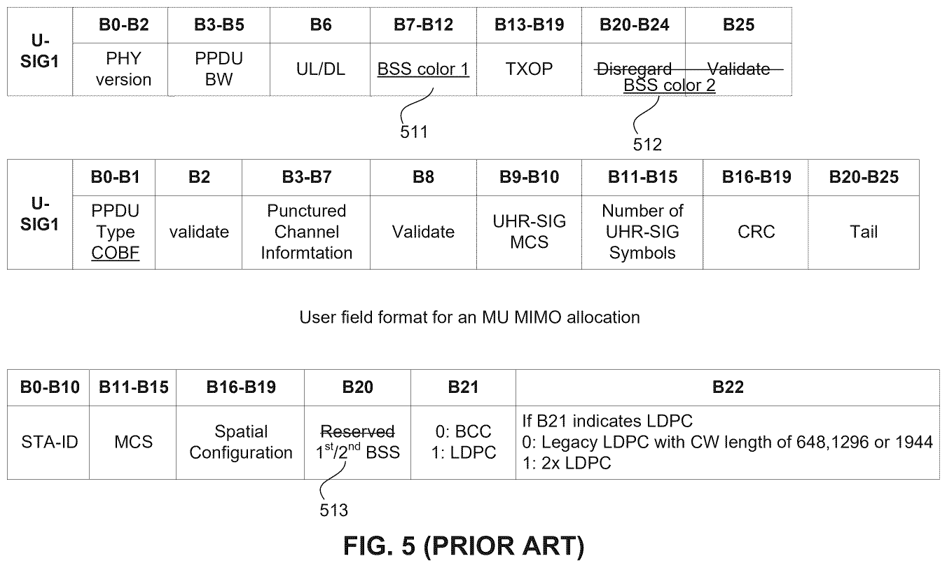

Another proposed solution in IEEE contribution 802.11bn-2024/1822r3 and schematically summarized herein in FIG. 5 involves signaling two BSS colors 511, 512 within the U-SIG field. This approach reuses the same STA ID as used in non-Co-BF transmissions within the user-field of the UHR-SIG field. To resolve potential STA ID collisions, each user-field in the UHR-SIG field includes an explicit 1-bit BSS indication 513. This bit helps differentiate between the two BSSs, ensuring that non-AP STAs can correctly identify which BSS the received transmission belongs to, thereby preventing conflicts and improving the overall coordination of downlink transmissions.

The above noted solution requires repurposing 7 to 10 bits in the PHY preamble 6 bits (B20-B25) for signaling a second BSS color 512 and 1 bit for BSS differentiation per STA, with a maximum of 4 STAs supported. Given the limited bit space in the PHY preamble, dedicating more than 7 bits solely to resolving the Association ID (AID) conflict issue is not optimal, as every bit in the PHY preamble is valuable.

Additionally, the above noted solution lacks scalability. It is designed to support only two APs in Co-BF at a time, which could be restrictive if future network generations enable the inclusion of more than two APs in Co-BF operations simultaneously. This limitation may hinder the ability to scale the solution for more complex network setups.

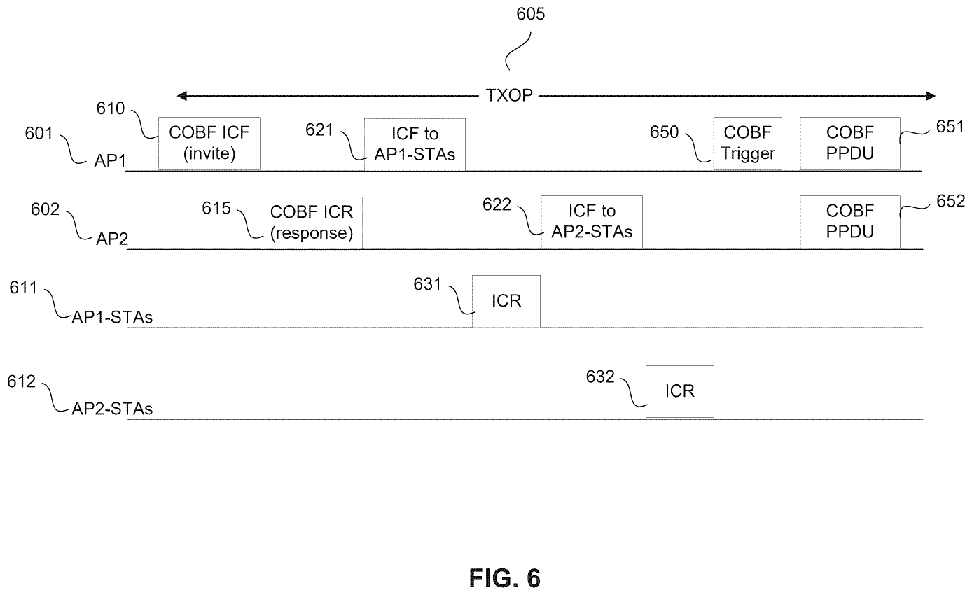

Embodiments of the present disclosure are applicable within the context of a Coordinated Beamforming transmission phase, generally pictured in FIG. 6. In Co-BF transmission phase, when one of the APs, such as the sharing AP1 of FIG. 6, obtains the TXOP 605, it initiates Co-BF by sending a Co-BF ICF (Co-BF Invite) 610 to invite the shared AP, such as AP2 of FIG. 6, for coordinated transmission and specifies its non-AP STAs it plans to serve within this TXOP 605 with the shared AP2 602. Within the Co-BF ICF (Co-BF Invite), the sharing AP can indicate if any of its associated (i.e., non-AP) STAs that the sharing AP plans to serve are an enhanced multi-link single radio (eMLSR) STAs or a dynamic power saving (DPS) STAs. For example, one bit within the Co-BF ICF (Co-BF Invite) can indicate the presence of any eMLSR or DPS STAs associated with the sharing AP to be served by the sharing AP during the Co-BF transmission phase. Also, the sharing AP includes, in the Co-BF ICF (Co-BF Invite), the carrier frequency offset (CFO) precorrection value and the precoding parameters estimated during the Co-BF sounding phase to be used within the Co-BF transmission phase.

The shared AP2 602 responds with a Co-BF ICR (Co-BF Response) 615 to acknowledge its ability to participate in the Co-BF transmission during shared TXOP 605 and declares its non-AP STAs it will serve. Within the Co-BF ICR (Co-BF Response), the shared AP can indicate if any of its associated (i.e., non-AP) STAs that the shared AP plans to serve are an enhanced multi-link single radio (eMLSR) STAs or a dynamic power saving (DPS) STAs. For example, one bit within the Co-BF ICR (Co-BF Response) can indicate the presence of any eMLSR or DPS STAs associated with the shared AP to be served by the shared AP during the Co-BF transmission phase. Also, the shared AP may include, in the ICR (Co-BF Response), the CFO precorrection value and the precoding parameters estimated during the Co-BF sounding phase to be used within the Co-BF transmission phase.

In embodiments, an ICF from the sharing AP includes an indication of a common BSS color to be used in a joint transmission of a Co-BF DL PPDU by the sharing AP and the shared AP, and an indication of a first plurality of STAs associated with the sharing AP (i.e., indicative of the STAs the sharing AP intends to serve under the current TXOP). The ICF may include a multi-AP (MAP) agreement identifier (ID) associated with the joint transmission of the Co-BF DL PPDU. The ICF may include a Co-BF instance ID associated with the joint transmission of the Co-BF DL PPDU. The ICF may include an indication of a first set of STA IDs for the first plurality of STAs associated with the sharing AP, the STAs of the first plurality of STAs being ready and available for receiving the joint transmission of the Co-BF DL PPDU. The ICF may include a 1-bit indication of a presence of an enhanced multi-link single radio (eMLSR) STA or a dynamic power saving (DPS) STA in the first plurality of STAs. The ICF may include a carrier frequency offset (CFO) precorrection value. The ICF may include a Sounding Dialog Token Number. The ICF may include additional control information associated with the joint transmission of the Co-BF DL PPDU. The ICF (e.g., ICF sent by sharing AP, ICF sent by shared AP) may be or may have a format of a trigger frame or a public action frame.

In embodiments, transmitting the first ICF towards the shared AP may include transmitting the first ICF towards both the shared AP and the first plurality of STAs, and the ICF can further include an indication of a first set of STA identifiers (IDs) for the first plurality of STAs. STA IDs of the first set of STA IDs can be distinct from STA IDs of a second set of STA IDs for the second plurality of STAs associated with the shared AP. The STA IDs being distinct may be pre-negotiated. The sharing AP may receive, from the shared AP, a second ICF that includes an indication of a second set of STA IDs associated with the shared AP, STA IDs within the second set of STA IDs being distinct from STA IDs within the first set of STA IDs.

In embodiments, and ICR from the shared AP is indicative of a participation of the shared AP in the joint transmission of the Co-BF DL PPDU, and indicative of a second plurality of STAs associated with the shared AP. The ICR may include a 1-bit indication of a presence of an enhanced multi-link single radio (eMLSR) STA or a dynamic power saving (DPS) STA in the second plurality of STAs. The ICR may include a carrier frequency offset (CFO) precorrection value and the precoding parameters. The ICR may include a Sounding Dialog Token Number. The ICR may be or may have a format of a trigger frame or a public action frame. The ICR format may correlate or match a corresponding ICF format.

Then, each AP confirms its readiness (may include the availability) of its associated (i.e., non-AP) STAs to be served. In some scenarios, some STAs might not be able to receive Co-BF DL PPDU immediately due to, for example, being an Enhanced Multi-link Single-Radio (eMLSR) STA, and such STA may need to activate the communication link first. In another example, some STAs might be in a power or resource saving mode where some time may be needed to transition from low capability operation to full capability operation.

In an embodiment, if the sharing AP does not receive any response from the non-AP STAs triggered by the ICF, it may terminate the Co-BF with the shared AP.

Finally, the sharing AP1 601 sends a Co-BF trigger 650 to the shared AP2 602 to provide synchronization reference and needed TX parameters for the joint transmission of the Co-BF DL PPDU.

In embodiments, the sharing AP can transmit towards the shared AP, a Co-BF trigger for the joint transmission of the Co-BF DL PPDU. The shared AP can receive the Co-BF trigger from the sharing AP. Toth the shared AP and the sharing AP can transmit the Co-BF DL PPDU having the common BSS color.

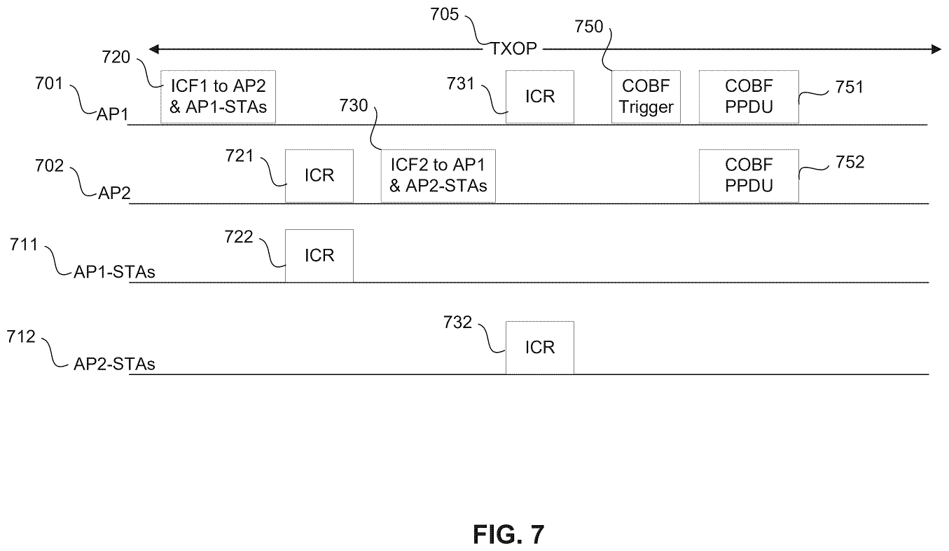

Certain efficiencies can be realized in this setup procedure, such efficiencies being applicable to all embodiments of the present disclosure, in the event that the shared and sharing APs both have the capability to participate, playing the role of a STA, in a Trigger Based (TB) uplink PPDU to another AP. In the case that AP2 supports TB PPDU, another frame sequence can be considered for Co-BF setup as illustrated in FIG. 7. AP1 701 can combine the Co-BF Invite and the ICF it sends to its served STAs 711 into a single ICF frame 720. Similarly, the Co-BF Response and the ICF sent by AP2 702 to its served STAs 712 can also be combined into one ICF frame 730. This approach reduces signaling overhead and delays.

In either aforementioned communication sequence of FIGS. 6 and 7, each AP must exchange ICF/ICR with its served or associated STAs before the actual Co-BF DL PPDU transmission to check the STAs' readiness, which can include STAs' availability, for receiving the data associated with the Co-BF DL PPDU transmission.

In some embodiments of the present disclosure, elements are added to this ICF/ICR exchange to resolve the STA ID conflict concurrently without causing any extra signaling overhead, thereby avoiding the need to use valuable PHY preamble bits or dedicated STA ID negotiation frames.

In a first broad aspect of the present disclosure, in the negotiation phase of Multi-AP Collaboration and before the sharing AP elects to share its TXOP with a shared AP, both sharing AP and shared AP agree on a common BSS color matching the Initiating/sharing AP's BSS color.

In embodiments, the common BSS color is one of: a Co-BF instance ID associated with the joint transmission of the Co-BF DL PPDU, a BSS color of the sharing AP, a pre-negotiated BSS color, and a negotiated value.

In an embodiment, the shared AP transmits towards a second plurality of STAs associated with the shared AP (STAs the shared AP intends to serve within the current TXOP), an indication of the common BSS color. The shared AP may transmit towards the sharing AP and the second plurality of STAs, a second ICF indicative of a participation of the shared AP in the joint transmission of the Co-BF DL PPDU and indicative of the second plurality of STAs. The second ICF may include the indication of the common BSS color.

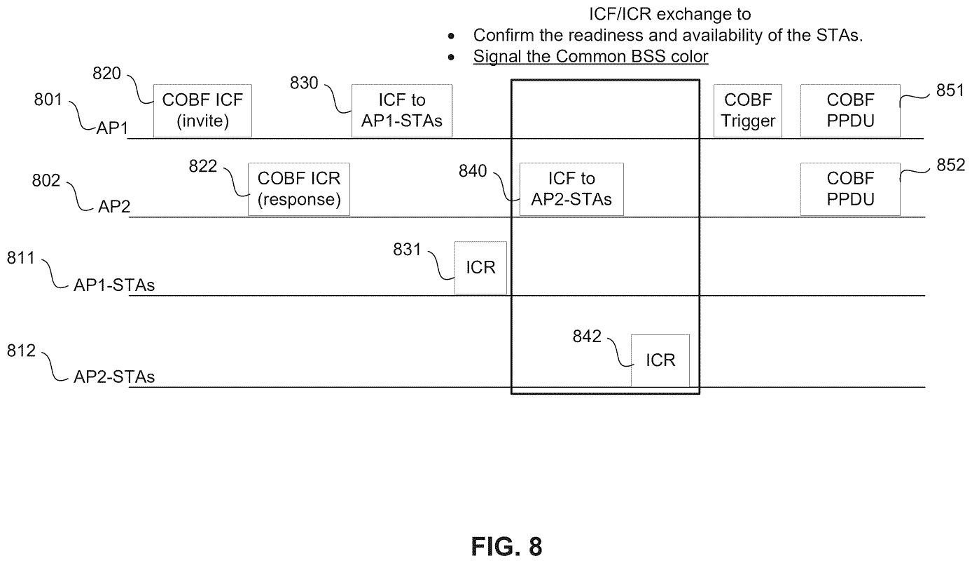

With reference to FIG. 8, after the Co-BF invite 820 and response 822 exchange, the shared AP 802 communicates a common BSS color (equal to the initiating, sharing, AP's 801 BSS color) for the Co-BF DL PPDU transmission to its served STAs 812 through the ICF/ICR exchange 840, 842 prior to the Co-BF DL PPDU transmission 851, 852.

As a result, during the Co-BF DL PPDU transmission 851, 852, the AP pair 801, 802 sets the value of the BSS color in the U-SIG field to a single common BSS color, which corresponds to the initiating AP's 801 BSS color. Further as a result, the AP pair 801, 802 sets the same STA IDs used for non-Co-BF transmissions into the user field of UHR-SIG field. Further as a result, the AP pair 801, 802 sets each user field's 1-bit indication of the BSS to “shared” or “sharing” to resolve STA ID collisions. This bit is set to 0 when the STA ID belongs to a STA that is served by or associated with the sharing AP 801, while this bit is set to 1 when the STA ID belongs to a STA that is served by or associated with the shared AP 802. These assignments can also be reversed without departing from the scope of the present disclosure.

The first broad aspect of the present disclosure, through utilizing one Common BSS color and 1-bit for BSS indication per user field, solves the STA-ID conflict issue while saving the 6 bits that may be required, for example, for the BSS Color 2 in 802.11bn-2024/1822r3, as described herein with reference to FIG. 5. This aspect can be accomplished through signaling by a series of frames, the details of which are now discussed, as applicable to the example CBD setup described herein with reference to FIG. 8. Embodiments of the first aspect include formats of the Co-BF Invite ICF frame and the Co-BF Response ICR frame.

The Co-BF ICF formats of the present invention are described below. The main purpose of the Co-BF ICF frame (used interchangeably with the ICF herein), which can be implemented as a trigger frame or a public action frame, according to embodiments, is to enable the sharing AP to initiate the Co-BF sounding or/and transmission phases with the shared AP(s). Additionally, the sharing AP can use the Co-BF ICF to communicate the MAP agreement ID, Co-BF instance ID, specify the non-AP STAs it plans to serve within the current TXOP with the shared AP(s), 1-bit indication of the presence of eMLSR or DPS STA(s) associated with the AP and that the AP intends to serve, CFO precorrection value, the precoding parameters, Sounding Dialog Token Number, other or additional to-be-determined (TBD) control info, or a combination thereof.

In embodiments, the Co-BF ICF frame, when formatted as a trigger frame, can be of any appropriate or suitable trigger frame type, such a ranging trigger frame (e.g., by setting the Trigger Type subfield value to ‘8’ in the UHR variant Common Info field), a multi-user block acknowledgement request (MU-BAR) trigger frame (e.g., by setting the Trigger Type subfield value to ‘2’), a multi-user request-to-send (MU-RTS) trigger frame (e.g., by setting the Trigger Type subfield value to ‘3’), or a buffer status report poll (BSRP) trigger frame (e.g., by setting the Trigger Type subfield value to ‘4’). In some embodiments, a new trigger frame variant may be defined as a Co-BF ICF trigger frame based on setting the value of the Trigger Type subfield to repurpose a reserved value (e.g., a value selected from the range 9 to 15).

In embodiments, another way to format the Co-BF Invite frame is to use a Public Action frame format. The Public Action frames are defined in the IEEE 802.11ax standard to allow the following inter-BSS and AP to unassociated-STA communications and intra-BSS communications.

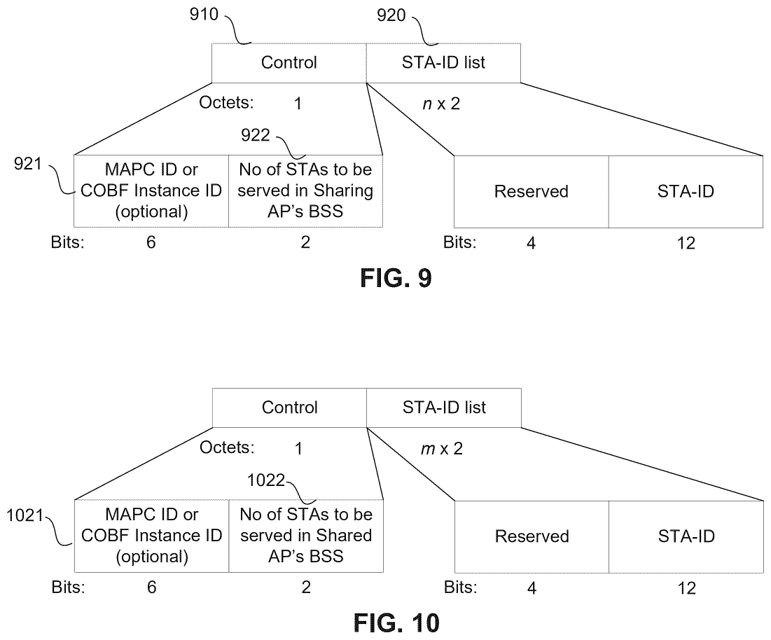

In an embodiment of the first aspect, a new Public Action Frame value is defined for Co-BF Invite frame by repurposing one of the reserved values in the public Action field (e.g., 54-59 or 61-255), as shown in Table 1. A value of 61, for example, may designate the Public Action frame as a Co-BF Invite frame. This frame, in accordance with public action frame formats defined in IEEE 802.11 standard, contains a Category value of 4 (Public Action), a public action field value of 61 (Co-BF invite), and an information element field called Co-BF Invite Information Field containing data particular to Co-BF invitation parameters, all depicted in Table 2. As illustrated in FIG. 9, the specific parameters carried in the Co-BF Invite Information Field comprise a control octet 910 and a STA-ID list 920 of two octets per candidate STA (n×2) declared in the invitation.

TABLE 1
Public Action field values

| Public Action | |
|---|---|
| field value | Description |
| 0 | 20/40 BSS Coexistence Management |
| 1 | DSE Enablement |
| 2 | DSE Deenablement |
| 3 | DSE Registered Location Announcement |
| . . . | . . . |
| 53 | EBCS termination notice (see 9.6.7.55 |
| | (EBCS Termination notice frame format(11be))) |
| 54-59 | Reserved |
| 60 | GAS Comeback Request Fragment |
| 61-255 | Reserved |

Repurpose one of the reserved values to indicate COBF Invite e.g., value 61

TABLE 2
Co-BF Invite Action field format

| Order | Information |
|---|---|
| 1 | Category = 4 (Public Action) |
| 2 | Public Action = 61 |
| 3 | Co-BF Invite Information field |

The first subfield of the Control octet, Multi-AP Coordination (MAPC) ID 921, may include a value selected from the Co-BF Instance ID, Sounding Dialog Token Number, or the pre-negotiated BSS color. This subfield is optional and it may be kept reserved or be used for any other TBD Co-BF key control info, e.g., No. of STAs expansion for future generations if this is allowed to be greater than four and requires more than two bits.

In an example embodiment, the No. of STAs to be served subfield 922 value of 0 may be reserved, a value of 1 may indicate 1 STA to be served by the sharing AP during the shared TXOP, a value of 2 may indicate 2 STAs to be served by the sharing AP during the shared TXOP, and a value of 3 may indicate 3 STAs to be served by the sharing AP during the shared TXOP.

In another example embodiment, the No. of STAs to be served subfield 922 value of 0 may indicate 1 STA to be served by the sharing AP during the shared TXOP, a value of 1 may indicate 2 STAs to be served by the sharing AP during the shared TXOP, and a value of 2 may indicate 3 STAs to be served by the sharing AP during the shared TXOP. A value of 3 may be reserved for future expansion (4 STAs, for example).

The value of the No. of STAs to be served subfield indicates also the value of n, the length of the STA-ID list field (how many 16-bit STA-ID fields will be included).

An alternate embodiment of an ICF frame is described below, and is useful in a scenario where the sharing AP obtains a TXOP but determines that it has no associated STAs ready and/or available to participate in the TXOP. In this case the sharing AP will not initiate Co-BF, but may share the whole duration of its TXOP to the shared AP using Coordinated Time Division Multiple Access (Co-TDMA). To this end, another new Public Action frame is disclosed, with reference to Table 3 and Table 4. A reserved value of Public Action, for example 63, may be dedicated to designate a Co-TDMA invitation frame. The Co-TDMA Invite Public Action frame format comprises a Category field of value 4, a Public Action field of value 63, and a Shared TXOP Duration field one octet in length.

In an embodiment, the sharing AP may determine that no STA within the first plurality of STAs associated with the sharing AP can participate in receiving (e.g., data associated with) the joint transmission of the Co-BF DL PPDU, and may share with the shared AP, a (i.e., current) TXOP associated with the joint transmission of the Co-BF DL PPDU, using Co-TDMA. The shared PA may receive, obtain, or take over, from the sharing AP, the TXOP associated with the joint transmission of the Co-BF DL PPDU, using Co-TDMA.

TABLE 3
Public Action field values

| Public Action | |
|---|---|
| field value | Description |
| 0 | 20/40 BSS Coexistence Management |
| 1 | DSE Enablement |
| 2 | DSE Deenablement |
| 3 | DSE Registered Location Announcement |
| . . . | . . . |
| 53 | EBCS termination notice (see 9.6.7.55 |
| | (EBCS Termination notice frame format(11be))) |
| 54-59 | Reserved |
| 60 | GAS Comeback Request Fragment |
| 61-255 | Reserved |

Repurpose one of the reserved values to indicate Co-TDMA Invitation e.g., value 63

TABLE 4
Co-TDMA Invite Action field format

| Order | Information |
|---|---|
| 1 | Category = 4 (Public Action) |
| 2 | Public Action = 63 |
| 3 | Shared TXOP Duration field (1 octet) |

In embodiments, the main purpose of the Co-BF ICR frame is to enable the shared AP to acknowledge its ability to participate in the Co-BF transmission with the sharing AP during the shared TXOP and declare the non-AP STAs it will serve and other TBD control info.

U.S. Provisional Patent Application No. 63/717,589 disclosed use of the Multi-STA Block-Ack (BA) frame as a trigger-based Co-BF ICR frame since it allows for multiple “Per AID TID Info” fields to be included in the “BA Information” field. However, another way to format the Co-BF Response frame is to use a Public Action frame format.

As mentioned in the discussion of other Public Action frame embodiments of the present disclosure, the Public Action frames are defined in the standard to allow the inter-BSS and AP to unassociated-STA communications and intra-BSS communications.

In an embodiment of the present disclosure, a new Public Action Frame value for Co-BF Response frame is established by repurposing one of the reserved values in the public Action field (e.g., 54-59 or 61-255, 62 used by way of an example), with reference to Table 5. The Co-BF Response Public Action frame format is presented in Table 6, containing a Category of value 4, a Public Action value 62, and a Co-BF Response Information Field. The Co-BF Response Information field, schematically illustrated in FIG. 10, is similar to the Co-BF Invite Information field in structure of FIG. 9, except the number of STAs to be served 1022 is reported for the shared (Responder) AP rather than the sharing (Inviting) AP.

TABLE 5
Public Action field values

| Public Action | |
|---|---|
| field value | Description |
| 0 | 20/40 BSS Coexistence Management |
| 1 | DSE Enablement |
| 2 | DSE Deenablement |
| 3 | DSE Registered Location Announcement |
| . . . | . . . |
| 53 | EBCS termination notice (see 9.6.7.55 |
| | (EBCS Termination notice frame format(11be))) |
| 54-59 | Reserved |
| 60 | GAS Comeback Request Fragment |
| 61-255 | Reserved |

Repurpose one of the reserved values to indicate COBF Response e.g., value 62

TABLE 6
Co-BF Response Action field format

| Order | Information |
|---|---|
| 1 | Category = 4 (Public Action) |
| 2 | Public Action = 62 |
| 3 | Co-BF Response Information field |

The structure of the Co-BF Response Information Field includes, with reference to FIG. 10, MAPC ID 1021 that may include the Co-BF Instance ID, Sounding Dialog Token Number, Pre-negotiated BSS color. This MAPC ID field 1021 is optional and it may be kept reserved or be used for any other TBD Co-BF key control info, e.g., No. of STAs expansion for future generations, 1-bit eMLSR or DPS non-AP STA present indication, CFO precorrection value, or a combination thereof. For No. of STAs to be served 1022, value of 0 is reserved, or in an alternate embodiment may be indicative of a declination of the invitation to participate in Co-BF. A value of 1 will indicate 1 STA to be served by the shared AP during the shared TXOP, a value of 2 will indicate 2 STAs to be served by the shared AP during the shared TXOP, and a value of 3 will indicate 3 STAs to be served by the shared AP during the shared TXOP. In another example embodiment, the No. of STAs to be served subfield value of 0 may indicate 1 STA to be served by the shared AP during the shared TXOP, a value of 1 may indicate 2 STAs to be served by the shared AP during the shared TXOP, and a value of 2 may indicate 3 STAs to be served by the shared AP during the shared TXOP. A value of 3 may be reserved for future expansion (4 STAs, for instance).

The value of the No. of STAs to be served subfield 1022 indicates also the value of m, the length of the STA-ID list field (how many 16-bit STA-ID fields will be included).

In IEEE 802.11bn standard, m has a maximum value of 4-n, where n is the number of STAs served by the sharing AP. In future generations, 5 or more STAs may be permitted to join a Co-BF instance from more than two BSS.

If the shared AP has no STA to serve during its obtained TXOP, it can reply with a declining response to the Co-BF Invite or neglect it.

In an embodiment of the present disclosure, another Public Action Frame is introduced by allocating another unique as-yet-reserved value of Public Action to denote a MAP TXOP sharing invitation Decline frame. In a non-limiting example, this Public Action value may be 64 as shown in Table 7. When declining a MAP TXOP sharing invitation, an AP need not provide any further information beyond the category of 4 and the Public Action value of, for example 64, and the frame structure shown in Table 8 is sufficient for the purpose.

TABLE 7
Public Action field values

| Public Action | |
|---|---|
| field value | Description |
| 0 | 20/40 BSS Coexistence Management |
| 1 | DSE Enablement |
| 2 | DSE Deenablement |
| 3 | DSE Registered Location Announcement |
| . . . | . . . |
| 53 | EBCS termination notice (see 9.6.7.55 |
| | (EBCS Termination notice frame format(11be))) |
| 54-59 | Reserved |
| 60 | GAS Comeback Request Fragment |
| 61-255 | Reserved |

Repurpose one of the reserved values to indicate MAP TXOP Sharing Invitation Decline e.g., value 64

TABLE 8
MAP TXOP Sharing Invitation Decline Action field format

| Order | Information |
|---|---|
| 1 | Category = 4 (Public Action) |
| 2 | Public Action = 64 |

With the Co-BF Invite and Response frame formats disclosed, attention is now turned to the ICF and ICR exchange between the sharing AP (also called AP1) and the associated STAs it plans to serve in the Co-BF instance. The main purpose of the ICF/ICR exchange between AP1 and its served STAs is to confirm their readiness and availability for Co-BF DL PPDU transmission.

In embodiments, the ICF frame, sent by the sharing AP1 to its served STAs can be of any appropriate or suitable trigger frame type, such as a multi-user block acknowledgement request (MU-BAR) trigger frame (e.g., by setting the Trigger Type subfield value to ‘2’), a multi-user request-to-send (MU-RTS) trigger frame (e.g., by setting the Trigger Type subfield value to ‘3’), or a buffer status report poll (BSRP) trigger frame (e.g., by setting the Trigger Type subfield value to ‘4’). Details of methods of implementing these or a novel ICF trigger frame with an as-yet reserved value of Trigger Type are disclosed in U.S. Provisional Patent Application No. 63/717,589.

The ICR frame type from the served STAs to the sharing AP1 depends on the type of the (e.g., trigger) frame sent in or utilized for the ICF. Fore example, for MU-BAR ICF, the STAs will send Block ACK or Multi-STA BA, for MU-RTS ICF, the STAs will send CTS, and for BSRP ICF, the STAs will send BSR or Multi-STA BA.

In embodiments, the shared AP (AP2) performs a similar ICF/ICR exchange with its associated STAs it plans to involve in the Co-BF instance. The main purpose of the ICF/ICR exchange between AP2 and its served STAs is to confirm their readiness and availability for Co-BF DL PPDU transmission, as well as, in the first broad aspect of the invention, signal the Common BSS color to be set in the BSS color field in the U-SIG field of the DL PPDU transmission.

The ICF frame, sent by the shared AP2 to its served STAs, can be of any appropriate trigger frame type similarly to the ICF frame sent by AP1, such as a multi-user block acknowledgement request (MU-BAR) trigger frame (e.g., by setting the Trigger Type subfield value to ‘2’), a multi-user request-to-send (MU-RTS) trigger frame (e.g., by setting the Trigger Type subfield value to ‘3’), or a buffer status report poll (BSRP) trigger frame (e.g., by setting the Trigger Type subfield value to ‘4’). For instance, if the ICF format will follow the buffer status report poll (BSRP) trigger frame (e.g., by setting the Trigger Type subfield value to ‘4’), the STAs will send BSR or Multi-STA BA as ICR.

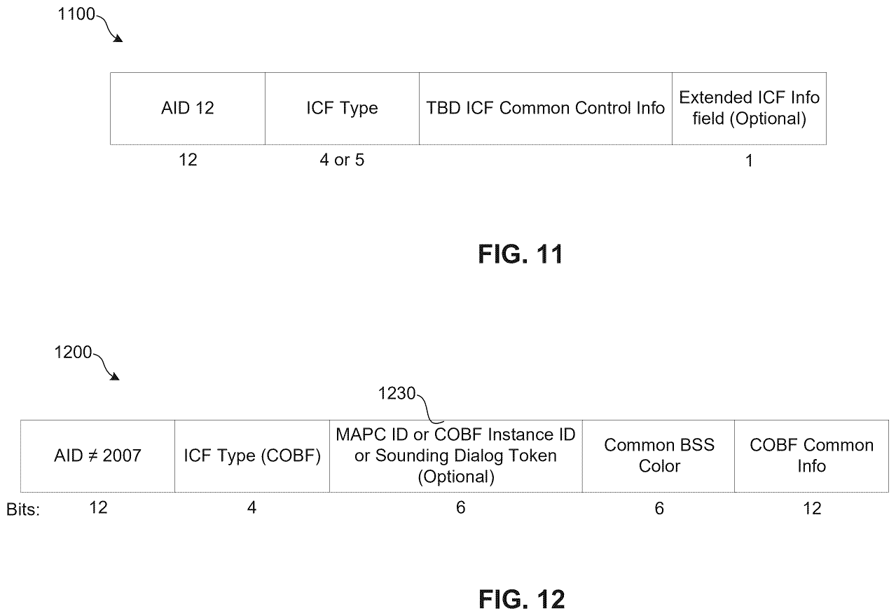

In a further embodiment of the present disclosure, the BSRP trigger frame may be enhanced in functionality by adding an Extended Special User Info field dedicated to ICF-type-specific Common information. This ICF Info field 1100 is formatted as shown in FIG. 11. For AID 12 this disclosure recommends a fixed value to the IEEE 802.11bn standard specification to identify this user field record as an ICF Info field. If this value falls within the range of 1-2006, the field will be placed immediately after the Special User Info field. If the value is greater than 2007, the field will be positioned following the User Info List. For an ICF type, this field is used to specify the type of the ICF, including options like Coordinated Beamforming (Co-BF), Coordinated Spatial Reuse (Co-SR), Coordinated TDMA (Co-TDMA), Coordinated Restricted Target Wake Time (Co-r-TWT), In-device Coexistence (IDC), Dynamic Sub-Band Operation (DSO), Non-primary Channel Access (NPCA), Dynamic Power Save (DPS), and other types to be determined (TBD).

In embodiments, if the ICF type is equal to a value corresponding to Co-BF, the main objective of the Extended Special User Info field is to carry the Common BSS Color Info to all served STAs. The format of the Extended Special User Info field 1200 can be as shown in FIG. 12. If the MAPC ID 1230 is not included, the remaining bits of the Co-BF Common Info total 18 bits. It will be appreciated that if the sharing AP1 and shared AP2 agreed on using another (e.g., pre-negotiated) common BSS color during the negotiation phase, ICF/ICR between AP1 and its served STAs will follow as the same formatting of the ICF/ICR between AP2 and its served STAs.

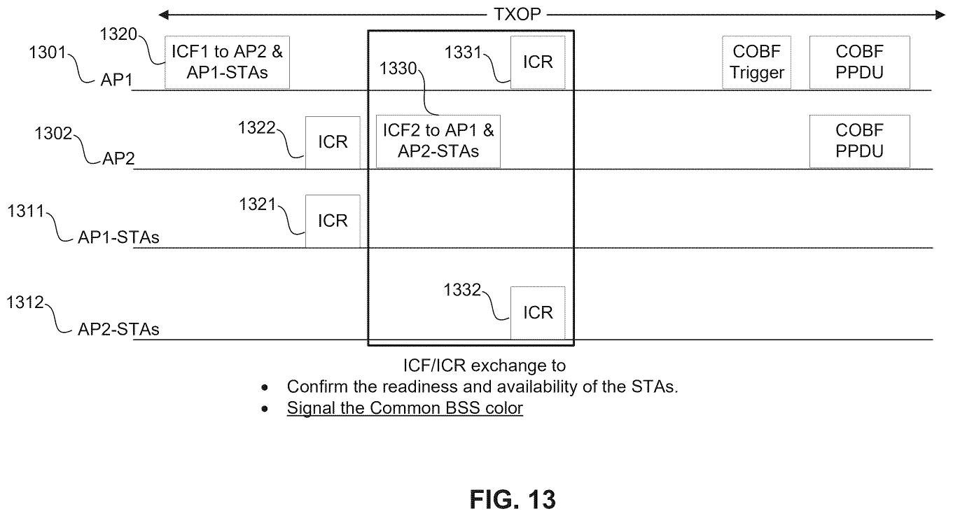

The preceding discussion of frame formats for Co-BF invite, Co-BF responses, declines, Co-TDMA invites, and ICRs and ICFs for sharing and shared APs and STAs has been in the context of the type of exchange wherein the Co-BF invites are not simultaneous with the AP-to-STA readiness and/or availability polling, i.e., the APs do not support the ability to respond to trigger frames as participants in UL MU TB PPDUs. If the APs do support this ability, certain efficiencies mentioned earlier can be realized, as shown in the message flow diagrams of FIG. 13 and FIG. 7 according to a second broad aspect of the invention. The public action Co-BF Invite and Response frames are not necessary in this aspect, as all AP-AP communication can instead happen via trigger frames and trigger-based frames, reducing latency and the overall time taken to setup the Co-BF.

In the second broad aspect of the present disclosure, the main purpose of the ICF/ICR exchange between AP1 and its served STAs is still to confirm their readiness and availability for Co-BF DL PPDU transmission, but with the added purpose of simultaneously inviting AP2 to participate in Co-BF transmission.

The ICF frame, sent by the sharing AP1 (e.g., AP1 1301 of FIG. 13) to its served STAs and the shared AP2 (e.g., ICF1 1320 to AP2 1302 & AP1-STAs 1311 of FIG. 13) can be of any appropriate frame type, such as a multi-user block acknowledgement request (MU-BAR) trigger frame (e.g., by setting the Trigger Type subfield value to ‘2’), as a multi-user request-to-send (MU-RTS) trigger frame (e.g., by setting the Trigger Type subfield value to ‘3’), or a buffer status report poll (BSRP) trigger frame (e.g., by setting the Trigger Type subfield value to ‘4’).

The ICR, from the served STAs (e.g., ICR 1321 of FIG. 13) and the shared AP (e.g., ICR 1322 of FIG. 13) back to the sharing AP1 (e.g., AP1 1301 of FIG. 13), depends on the type of the trigger frame sent in the ICF. For instance, for MU-BAR ICF, the STAs and AP2 will send Block ACK or Multi-STA BA, for MU-RTS ICF, the STAs and AP2 will send CTS, and for BSRP ICF, the STAs and AP2 will send BSR or Multi-STA BA.

The major difference from the previous signaling to merely AP1's associated STAs is adding one User Info field to the trigger frame, destined for AP2, in which the AID subfield includes an AP ID assigned to AP2 by the sharing AP during the negotiation phase. This essentially allows AP1 to address AP2 in a trigger frame as if AP2 was a STA associated with AP1's BSS. The difference in the ICR trigger-based response frame is that AP2 uses fields in its assigned resources of the trigger-based ICR, such as Block Ack, in a non-limiting example of a Multi-STA BA trigger-based ICR, to accept or decline the Co-BF invitation.

In the all-trigger-frame embodiment of the ICF/ICR exchange from AP2 to AP1 and AP2's served STAs, the main purpose of the ICF/ICR exchange is to confirm AP2's STAs' readiness and availability for receiving data associated with the joint Co-BF DL PPDU transmission, as well as signal the Common BSS color to AP2's STAs to be set in the BSS color field in the U-SIG field of the DL PPDU transmission.

The ICF frame, sent by the shared AP2 to its served STAs and AP1 (e.g., ICF2 1330 to AP1 1301 & AP2-STAs 1312 of FIG. 13) can again be of any appropriate frame type, such as a multi-user block acknowledgement request (MU-BAR) trigger frame (e.g., by setting the Trigger Type subfield value to ‘2’), as a multi-user request-to-send (MU-RTS) trigger frame (e.g., by setting the Trigger Type subfield value to ‘3’), or a buffer status report poll (BSRP) trigger frame (e.g., by setting the Trigger Type subfield value to ‘4’).

For instance, if the ICF format will follow the buffer status report poll (BSRP) trigger frame (e.g., by setting the Trigger Type subfield value to ‘4’), the STAs will send BSR or Multi-STA BA as ICR (e.g., ICR 1332 of FIG. 13). Similar formatting is applicable to the ICR from the AP1 (e.g., ICR 1331 of FIG. 13).

The only essential difference from the previous signaling merely to AP2's served STAs (e.g., as described herein with reference to FIG. 8) is adding one User Info field destined for AP1 in which the AID subfield includes an AP1 ID negotiated during the negotiation phase, enabling AP1 to act as a UL participant in TB PPDUs to AP2.

The all-trigger-frame Co-BF setup between the shared and sharing APs thus saves the duration of the Public Action based Co-BF invites and responses, as well as the interframe spacing therebetween, consuming less of the TXOP and decreasing the latency of both BSSs involved in the Co-BF instance. Also, the STA ID conflict is resolved because a common BSS color is communicated and a disambiguation bit is used to differentiate STAs with equal AID12 belonging to AP1's BSS and AP2's BSS.

In embodiments, STA IDs of the first set of STA IDs can be distinct from STA IDs of a second set of STA IDs for the second plurality of STAs associated with the shared AP. The STA IDs being distinct may be pre-negotiated. For example, the STA IDs of the first set of STA IDs and the STA IDs of the second set of STA IDs may be selected from an Association Identifier (AID) pool comprising 2006 AIDs. Alternatively, each STA ID of the first set of STA IDs may include a same 2 or 3 bit BSS ID. Similarly, each STA ID of the second set of STA IDs may include the same 2 or 3 bit BSS ID.

In an embodiment, the shared AP may receive from the sharing AP, an indication of a set of STA IDs for the first plurality of STAs associated with the sharing AP, the set including a first STA ID that matches an ID of a STA of the second plurality of STAs associated with the shared AP. The shared AP may change the matching ID of its associated STA to a new STA ID and transmit an indication of the set of STA IDs associated with the shared AP to the second plurality of STAs associated with the shared AP that includes the new STA ID that is distinct from STA IDs for the first plurality of STAs associated with the sharing AP. The shared AP may transmit such indication to its associated plurality of STAs jointly with the indication of the common BSS color.

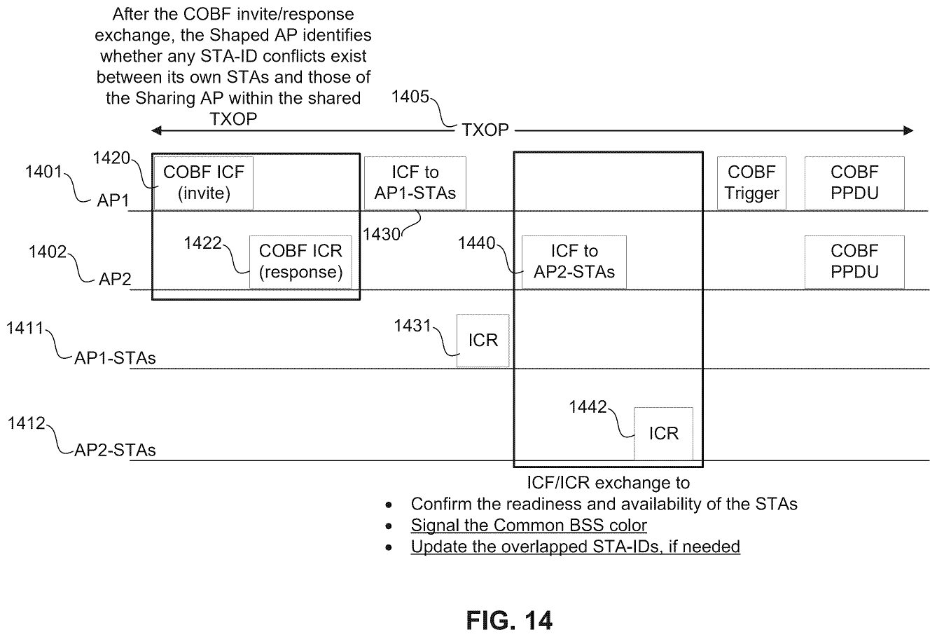

A third broad aspect of the present disclosure eliminates the need for a disambiguation bit that places STAs in one of two bins—shared or sharing AP. By actually setting all STA IDs in a Co-BF instance to be mutually unequal to each other across any number of participating BSSs, not only is the disambiguation bit unnecessary, but this lack of a binary dichotomy opens up the possibility of more than two BSSs participating in a Co-BF instance. For example, given sufficient spatial resources (namely antennas), four BSSs could participate, with 8 total STAs receiving a data associated with the joint Co-BF DL PPDU transmission according to the third broad aspect, described below by way of an example and with reference to FIG. 14.

With reference to FIG. 14, once AP1 1401 obtains TXOP 1405, it initiates a Co-BF Invite 1420 to AP2 1402 and declares, within the ICF 1420 e.g., via a corresponding indication that may be a part of the ICF 1420, its (i.e., non-AP) STAs that are associated with the AP1 1401 and that it intends to serve within this TXOP. AP1 1401 can send an ICF 1430 to its associated STAs 1411 to confirm their readiness for receiving the, e.g. data associated with, the Co-BF DL PPDU for this TXOP, and can receive one or more ICRs 1431 therefrom. In response, AP2 1402 sends a Co-BF Response 1422 to AP1 1401, declaring, e.g., via a corresponding indication that may be a part of the ICR 1422, its own (i.e., non-AP) STAs 1412, associated with the AP2 and that it intends to serve. The AP2 1402 can send ICF 1440 to STAs 1412 to confirm STAs scheduled for service within the same TXOP 1405, and can receive one or more ICRs 1442 therefrom. If the shared AP 1402 detects any STA ID conflict between its own STAs 1412 and STAs 1411 of the sharing AP 1401 for this TXOP 1405 that it received via the ICF 1420, it updates the STA IDs of only the affected STAs of all the STAs 1412 it serves. This update is communicated through the subsequent ICF 1440/ICR 1442 exchange between AP2 1402 and its served STAs 1412. This update can be applied permanently or temporarily during the current Co-BF DL PPDU transmission only. Within the same ICF 1440/ICR 1442 exchange, the shared AP 1402 shares with its associated STAs 1412 a common BSS color that matches the sharing AP's BSS color. If AP1 1401 and AP2 1402 have agreed on another pre-negotiated Common BSS color, the sharing AP 1401 has to share this common BSS color with its served STAs 1411 through the ICF 1430 sent from AP1 1401 to AP1-STAs 1411.

This aspect eliminates the need for incorporating the two BSS colors of the prior art and any additional 1-bit BSS indication per user field to resolve STA ID conflicts, thereby conserving valuable bits in the PHY preamble. Moreover, this approach is scalable, enabling support for more than two APs in Co-BF concurrently, provided future generations of the framework allow the inclusion of more APs than two in Co-BF operations.

To implement this aspect, most of the same frame formats can be re-used from the first broad aspect, described earlier herein, that communicated a common BSS color and the disambiguation bit. The common BSS color is still utilized, but in the third broad aspect the shared AP has the responsibility of changing the AID12s of any of its STAs that shall participate in the Co-BF instance. shared AP2 shall do this via an Extended User Info field in the ICF frame that it sends to its associated STAs. This approach is intended both for the case of separate Co-BF invitation and STA polling, or unified Co-BF invitation and STA polling, also called the all-trigger-frame case.

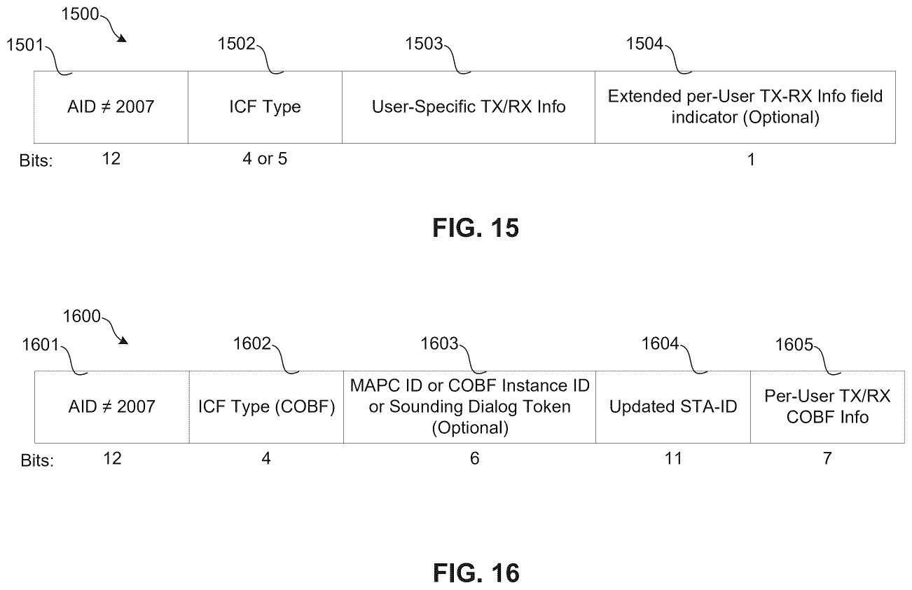

Notably, the above Extended User Info field is differentiated from the Extended Special User Info field that is shown in general ICF format for all ICF trigger frames in FIG. 11 and in specific Co-BF format for Co-BF ICFs in FIG. 12, which occurs once per trigger frame and carries common information. The above noted Extended User Info Field is the per-user record in the user-list of the general ICF. This per-User TX/RX Info field is formatted for general ICF use as in FIG. 15 and for specific Co-BF ICF use in FIG. 16.

With reference to FIGS. 15 and 16, AID12 1501, 1601 of each user record matches the AID12 of one STA addressed by the trigger frame, similar to the function of any other trigger frame user list. ICF type field 1502, 1602 is used to specify the type of ICF, including options like Coordinated Beamforming (Co-BF), Coordinated Spatial Reuse (Co-SR), Coordinated TDMA (Co-TDMA), Coordinated Restricted Target Wake Time (Co-r-TWT), In-device Coexistence (IDC), Dynamic Sub-Band Operation (DSO), Non-primary Channel Access (NPCA), Dynamic Power Save (DPS), and other types to be determined (TBD).

For the Co-BF transmission case, the main objective of the per-User TX/RX Info field 1605 is to carry the updated STA ID info per user and other user specific parameters. The format of the Extended Special User Info field then follows the format of FIG. 16 with the 11 bits 1604 after the MAPC ID 1603 used to let the STA identified in the first 12 bits 1601 know what its new STA ID 1604 is for the duration of this Co-BF instance. In another embodiment, the STA may keep the new STA ID beyond the end of the Co-BF instance, up to the duration of its association with its BSS.

If the MAPC ID 1603 is not included, the remaining bits of the per-User TX/RX Co-BF Info 1605 is 13 bits instead of 7. It will be appreciated that if the sharing AP1 and shared AP2 agreed on using another common BSS color during the negotiation phase, the ICF/ICR between AP1 and its served STAs will follow as the same formatting as the ICF/ICR between AP2 and its served STAs.

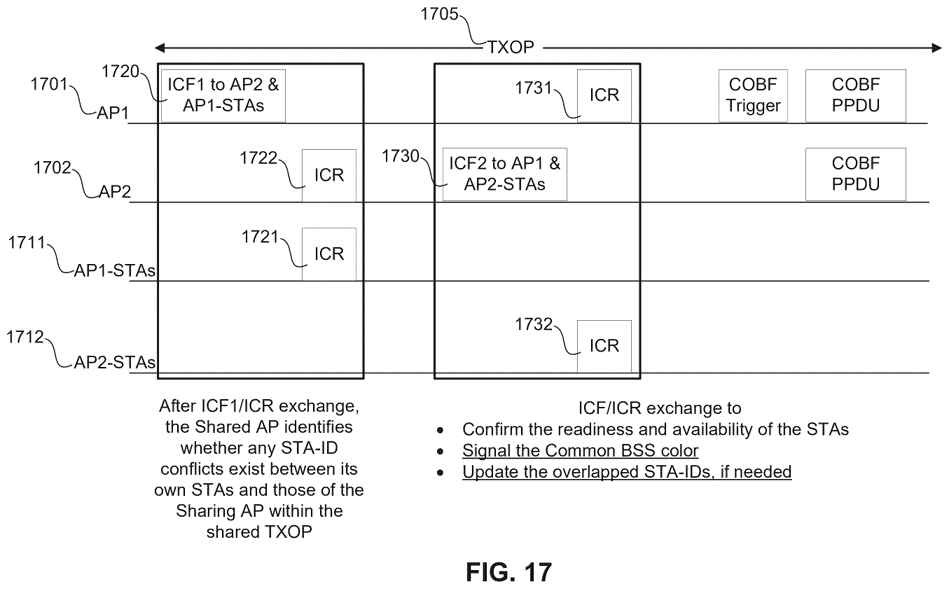

For clarity, it is reiterated that in embodiments of the third broad aspect, updating conflicting STA IDs by the shared AP via the Extended User Info field, is also applicable to embodiments of the second broad aspect in that APs support receiving trigger frames and participating in trigger-based UL PPDUs back to other APs, and further applicable to embodiments of the first broad aspect in that only one common BSS color is needed to uniquely identify all STAs in a Co-BF. FIG. 17 shows a messaging diagram annotated with the above-described reassignment of STA IDs by AP2, in a combination of the first, second and third broad aspects of the present disclosure.

With reference to FIG. 17, AP1 1701 can combine the Co-BF Invite and the ICF it sends to its served STAs 1711 into a single ICF1 frame 1720. Similarly, the Co-BF Response and the ICF sent by AP2 1702 to its served STAs 1712 can also be combined into one ICF2 frame 1730. The ICF1 frame 1720, sent by the sharing AP1 1701 to its served STAs 1711 and the shared AP2 1702 can be of any appropriate frame type, as discussed elsewhere herein. The type or format of the ICRs, such as ICR 1721 from the AP1's served STAs 1711 and ICR 1722 from the shared AP 1702, back to the sharing AP1 1701, depends on the type of the trigger frame sent in the ICF1 1720, as discussed elsewhere herein. Similarly, the format or type of the ICF2 1730 as subsequent ICRs 1731 and 1732 depend on the type of the trigger frame sent in the ICF1 1720.

In a fourth broad aspect of the present disclosure, any and all APs participating in a Co-BF may pre-emptively assign their STAs temporary Co-BF STA IDs in the Pre-TXOP negotiation phase, before ICFs are sent.

In embodiments, each AP pair (i.e., a sharing AP and a shared AP) may pre-negotiate a common BSS color and non-overlapping range of Co-BF STA IDs for each AP's associated STAs in a one-time agreement during the MAP Coordination Agreement Negotiation stage. This negotiation can be carried out, for example, using Public Action frames disclosed in U.S. Provisional Patent Application No. 63/717,589. The common BSS color may equal to the Co-BF Instance ID. The Co-BF Instance ID may equal to a Multi-AP Coordination Agreement (MAPCA) ID, used by any AP when exchanging management or control frames between any subset of APs that are members of this agreement.

Regarding the non-overlapping range of Co-BF STA IDs, given that the User Info field's AID pool contains 2006 AIDs, AP1 and AP2 could agree to split this range, with AP1 using Co-BF STA IDs 1-1003 and AP2 using Co-BF STA-IDs 1004-2006, for example. Any other STA ID range splitting ratio can be considered, as long as it can accommodate the maximum supported associated STAs for each AP. Notably, if future network generations allow for including more than two APs in Co-BF simultaneously, the non-overlapped STA ID range allocations need to accommodate the maximum supported associated STAs for each AP.

At the end of the pre-TXOP negotiation phase, each AP would then communicate the common BSS color and Co-BF STA-IDs to its associated STAs via ICFs using Extended User Info Fields as described elsewhere herein with reference to the third broad aspect. In embodiments of the fourth broad aspect, Co-BF STA IDs are temporary IDs, only used for current Co-BF DL PPDU transmission and not maintained afterwards.

During the Co-BF DL transmission, once a non-AP STA decodes the common BSS color in the U-SIG, which includes the Co-BF Instance ID, it will reference the pre-negotiated MAPC agreement to identify its designated non-overlapping Co-BF STA ID specifically allocated for Co-BF downlink transmissions.

A second embodiment of the fourth broad aspect extends the negotiation of valid non-overlapping ranges of STA IDs to schemes involving more than two APs. With only two APs, it is appreciated that the APs can split the available address pool roughly in half, 1-1003 and 1004-2006 being suggested above in a non-limiting example. In another non-limiting example, ranges 1-1023 and 1024-2006 also serve the purpose of roughly splitting the pool in half but with one additional salient feature—all of the addresses in one pool have the 210 bit set to 0, and the others have it set to 1. Essentially this bit of the AID becomes a BSS identifier. The number of bits used for this virtual BSS identifier can be extended as the number of APs participating grows beyond 2 in future PHY versions. With the 210 and 29 bits used for BSS identifier, four BSSs, and four address pools, can be assigned: 1-511, 512-1023, 1024-1535, and 1536-2006, for example.

A general format for the Co-BF STA ID is proposed, according to an embodiment of the fourth broad aspect, illustrated in Table 9. An 11-bit Co-BF STA ID uses the 2 or 3 most significant bits (MSBs) as a fixed BSS pool identifier, and the remaining bits as a varying STA ID unique within the pool for perhaps 256 to 512 STAs associated with that BSS. APs need only negotiate their prefix bits in the pre-TXOP negotiation phase, then APs can set the remaining bits by any means and are guaranteed Co-BF IDs that are unique in the current Co-BF instance.

TABLE 9
Example embodiment of APs in a Co-BF negotiation partitioning
the available STA-ID address space with each AP assigned a
pool of STA-IDs with a fixed set of Most Significant Bits

| Fixed BSS pool ID | Varying STA ID |
|---|---|
| 2 or 3 | 9 or 8 |

11-bit STA-ID

In the foregoing embodiments of the present invention, New control frames (ICF and ICR) are introduced to facilitate coordination during the Co-BF sounding and transmission phases and to declare the specific STAs to be served by the sharing and shared APs during the Co-BF shared TXOP. Medium Access Control (MAC) layer solutions are disclosed for APs to pre-negotiate non-overlapping AID ranges for STAs, mitigating the STA AID conflicts of the prior art with greater efficiency. Standardized signaling is thus established between APs and STAs, ensuring efficient setup of Co-BF transmissions and conflict-free communication among coordinated APs. Reliability and efficiency are improved in serving overlapping STAs, with savings of valuable PHY preamble bits. Precise identification is enabled of the STAs each AP will serve, enhancing clarity and coordination in MAP Co-BF groups.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising, at a sharing access point (AP) of a wireless communication network:
transmitting, towards a shared AP of the wireless communication network, a first initial control frame (ICF) comprising:
an indication of a common basic service set (BSS) color to be used in a joint transmission of a coordinated beamforming (Co-BF) downlink (DL) physical layer protocol data unit (PPDU) by the sharing AP and the shared AP; and
an indication of a first plurality of stations (STAs) associated with the sharing AP; and
receiving, from the shared AP, an initial control response (ICR) indicative of a participation of the shared AP in the joint transmission of the Co-BF DL PPDU, and indicative of a second plurality of STAs associated with the shared AP.

2. The method of claim 1, further comprising:
transmitting, towards the shared AP, a Co-BF trigger for the joint transmission of the Co-BF DL PPDU; and
transmitting the Co-BF DL PPDU having the common BSS color.

3. The method of claim 1, wherein transmitting the first ICF towards the shared AP comprises transmitting the first ICF towards both the shared AP and the first plurality of STAs, the ICF further comprising an indication of a first set of STA identifiers (IDs) for the first plurality of STAs.

4. The method of claim 1, further comprising:
transmitting, towards the first plurality of STAs, an indication of a first set of STA identifiers (IDs) for the first plurality of STAs, STA IDs of the first set of STA IDs being distinct from STA IDs of a second set of STA IDs for the second plurality of STAs.

5. The method of claim 4, wherein the STA IDs of the first set of STA IDs and the STA IDs of the second set of STA IDs are selected from an Association Identifier (AID) pool comprising 2006 AIDs.

6. The method of claim 4, wherein each STA ID of the first set of STA IDs comprises a same 2 or 3 bit BSS ID.

7. The method of claim 3, further comprising:
receiving, from the shared AP, a second ICF comprising an indication of a second set of STA IDs associated with the shared AP, STA IDs within the second set of STA IDs being distinct from STA IDs within the first set of STA IDs.

8. The method of claim 1, wherein the first ICF further comprises one or more of:
a multi-AP (MAP) agreement identifier (ID) associated with the joint transmission of the Co-BF DL PPDU;
a Co-BF instance ID associated with the joint transmission of the Co-BF DL PPDU;
an indication of a first set of STA IDs for the first plurality of STAs, the STAs of the first plurality of STAs being ready for receiving the joint transmission of the Co-BF DL PPDU;
a 1-bit indication of a presence of an enhanced multi-link single radio (eMLSR) STA or a dynamic power saving (DPS) STA in the first plurality of STAs;
a carrier frequency offset (CFO) precorrection value;
precoding parameters;
a Sounding Dialog Token Number; and additional control information associated with the joint transmission of the Co-BF DL PPDU.

9. The method of claim 1, wherein the ICR further comprises one or more of:
a 1-bit indication of a presence of an enhanced multi-link single radio (eMLSR) STA or a dynamic power saving (DPS) STA in the second plurality of STAs;
a carrier frequency offset (CFO) precorrection value;
precoding parameters; and
a Sounding Dialog Token Number.

10. The method of claim 1, further comprising:
determining that no STA within the first plurality of STAs can participate in receiving the joint transmission of the Co-BF DL PPDU; and
sharing, with the shared AP, a transmission opportunity (TXOP) associated with the joint transmission of the Co-BF DL PPDU, using Coordinated Time Division Multiple Access (Co-TDMA).

11. The method of claim 1, wherein the common BSS color is one of:
a Co-BF instance ID associated with the joint transmission of the Co-BF DL PPDU;
a BSS color of the sharing AP;
a pre-negotiated BSS color; and
a negotiated value.

12. The method of claim 1, wherein the first ICF is a trigger frame or a public action frame.

13. A method comprising, at a shared access point (AP) of a wireless communication network:
receiving, from a sharing AP of the wireless communication network, a first initial control frame (ICF) comprising:
an indication of a common basic service set (BSS) color to be used in a joint transmission of a coordinated beamforming (Co-BF) downlink (DL) physical layer protocol data unit (PPDU) by the sharing AP and the shared AP; and
an indication of a first plurality of stations (STAs) associated with the sharing AP; and
transmitting, towards a second plurality of STAs associated with the shared AP, an indication of the common BSS color.

14. The method of claim 13, further comprising:
transmitting, towards the sharing AP and the second plurality of STAs, a second ICF indicative of a participation of the shared AP in the joint transmission of the Co-BF DL PPDU and indicative of the second plurality of STAs, the second ICF comprising the indication of the common BSS color.

15. The method of claim 13, further comprising:
transmitting, towards the second plurality of STAs, an indication of a first set of STA identifiers (IDs) for the second plurality of STAs, STA IDs of the first set of STA IDs being distinct from STA IDs of a second set of STA IDs for the first plurality of STAs associated with the sharing AP.

16. The method of claim 15, wherein the indication of the common BSS color and the indication of the first set of STA IDs are transmitted jointly.

17. The method of claim 15, wherein the STA IDs of the first set of STA IDs and the STA IDs of the second set of STA IDs are selected from an Association Identifier (AID) pool comprising 2006 AIDs.

18. The method of claim 15, wherein each STA ID of the first set of STA IDs comprises a same 2 or 3 bit BSS ID.

19. The method of claim 15, further comprising:
receiving, from the sharing AP, an indication of the second set of STA IDs, the second set of STA IDs including a first STA ID, a STA of the second plurality of STAs having the first STA ID,
wherein the first set of STA IDs includes a new STA ID for the STA of the second plurality of STAs, the new STA ID being distinct from the first STA ID.

20. The method of claim 19, wherein the first ICF comprises the indication of the second set of STA IDs.

21. The method of claim 13, further comprising:
receiving, from the sharing AP, a Co-BF trigger for the joint transmission of the Co-BF DL PPDU; and
transmitting the Co-BF DL PPDU having the common BSS color.

22. The method of claim 13, wherein the first ICF further comprises one or more of:
a multi-AP (MAP) agreement identifier (ID) associated with the joint transmission of the Co-BF DL PPDU;
a Co-BF instance ID associated with the joint transmission of the Co-BF DL PPDU;
an indication of STAs of the second plurality of STAs, ready for receiving the joint transmission of the Co-BF DL PPDU;
a 1-bit indication of a presence of an enhanced multi-link single radio (eMLSR) STA or a dynamic power saving (DPS) STA in the first plurality of STAs;
a carrier frequency offset (CFO) precorrection value;
precoding parameters;
a Sounding Dialog Token Number; and
additional control information associated with the joint transmission of the Co-BF DL PPDU.

23. The method of claim 13, further comprising:
transmitting, toward the sharing AP, an initial control response (ICR) indicative of:
a participation of the shared AP in the joint transmission of the Co-BF DL PPDU;
an indication of the second plurality of STAs associated with the shared AP; and
one or more of:
a 1-bit indication of a presence of an enhanced multi-link single radio (eMLSR) STA or a dynamic power saving (DPS) STA in the second plurality of STAs;
a carrier frequency offset (CFO) precorrection value;
precoding parameters; and
a Sounding Dialog Token Number.

24. The method of claim 13, further comprising:
receiving, from the sharing AP, a transmission opportunity (TXOP) associated with the joint transmission of the Co-BF DL PPDU, using Coordinated Time Division Multiple Access (Co-TDMA).

25. The method of claim 13, wherein the common BSS color is one of:
a Co-BF instance ID associated with the joint transmission of the Co-BF DL PPDU;
a BSS color of the sharing AP;
a pre-negotiated BSS color; and
a negotiated value.

26. The method of claim 13, wherein the first ICF is a trigger frame or a public action frame.

27. A sharing access point (AP) of a wireless communication network, the sharing AP configured to:
transmit, towards a shared AP of the wireless communication network, a first initial control frame (ICF) comprising:
an indication of a common basic service set (BSS) color to be used in a joint transmission of a coordinated beamforming (Co-BF) downlink (DL) physical layer protocol data unit (PPDU) by the sharing AP and the shared AP; and
an indication of a first plurality of stations (STAs) associated with the sharing AP; and
receive, from the shared AP, a first initial control response (ICR) indicative of a participation of the shared AP in the joint transmission of the Co-BF DL PPDU, and indicative of a second plurality of STAs associated with the shared AP.

28. The sharing AP of claim 27, wherein the first ICF further comprises one or more of:
a multi-AP (MAP) agreement identifier (ID) associated with the joint transmission of the Co-BF DL PPDU;
a Co-BF instance ID associated with the joint transmission of the Co-BF DL PPDU;
an indication of a first set of STA IDs for the first plurality of STAs, the STAs of the first plurality of STAs being ready for receiving the joint transmission of the Co-BF DL PPDU;
a 1-bit indication of a presence of an enhanced multi-link single radio (eMLSR) STA or a dynamic power saving (DPS) STA in the first plurality of STAs;
a carrier frequency offset (CFO) precorrection value;
precoding parameters;
a Sounding Dialog Token Number; and
additional control information associated with the joint transmission of the Co-BF DL PPDU.

29. A shared access point (AP) of a wireless communication network, the shared AP configured to:
receive, from a sharing AP of the wireless communication network, a first initial control frame (ICF) comprising:
an indication of a common basic service set (BSS) color to be used in a joint transmission of a coordinated beamforming (Co-BF) downlink (DL) physical layer protocol data unit (PPDU) by the sharing AP and the shared AP; and
an indication of a first plurality of stations (STAs) associated with the sharing AP; and
transmit, towards a second plurality of STAs associated with the shared AP, an indication of the common BSS color.

30. The shared AP of claim 29, further configured to:
transmit, toward the sharing AP, an initial control response (ICR) indicative of:
a participation of the shared AP in the joint transmission of the Co-BF DL PPDU;
the second plurality of STAs associated with the shared AP; and
one or more of:
a 1-bit indication of a presence of an enhanced multi-link single radio (eMLSR) STA or a dynamic power saving (DPS) STA in the second plurality of STAs;
a carrier frequency offset (CFO) precorrection value;
precoding parameters; and
a Sounding Dialog Token Number.
